(19) United States
(12) Patent Application Publication
(10) Pub. No.: US 2025/0292597 A1
(43) Pub. Date: Sep. 18, 2025

(54) METHOD FOR DETERMINING A REGION OF INTEREST IN AN IMAGE OF A BIOLOGICAL SAMPLE

(71) Applicant: TRIBUN HEALTH, PARIS (FR)

(72) Inventors: Saïma BEN HADJ, PARIS (FR); Rutger FICK, PARIS (FR)

(73) Assignee: TRIBUN HEALTH, PARIS (FR)

(21) Appl. No.: 18/858,877

(22) PCT Filed: Apr. 21, 2023
(86) PCT No.: PCT/EP2023/060522

§ 371 Date: Oct. 22, 2024

(30) Foreign Application Priority Data
Apr. 22, 2022 (FR) 2203774

(51) Int. Cl. G06V 20/69; G01N 1/30; G06T 7/00; G06T 7/11; G06T 7/136; G06V 10/764; G06V 10/776; G06V 10/82

(52) U.S. Cl. CPC G06V 20/695; G01N 1/30; G06T 7/0012; G06T 7/11; G06T 7/136; G06V 10/764; G06V 10/776; G06V 10/82; G06V 20/698; G06T 2207/10024; G06T 2207/10056; G06T 2207/20021; G06T 2207/20081; G06T 2207/20084; G06T 2207/30024

(57) ABSTRACT

A method for determining a region of interest in an image of a biological sample using a machine learning model trained on training data including: first images of biological samples prepared using a first staining technique, and information relating to regions of interest in the first images; and N pairs of images, each pair of images including an image of a respective biological sample prepared with an nth staining technique, so-called the n second image, and an image of the same biological sample prepared with the first staining technique, so-called the n third image, N being an integer greater than or equal to 1 and n being an integer between 2 and N+1; and wherein the calculation and the optimization of a cost function are performed on the basis of the training images which are segmented using current parameters of the machine learning model.

### FIELD

The present invention relates to the field of digital pathology, in particular the detection of regions of interest in images of biological samples obtained by staining.

### BACKGROUND

During the last decade, the development of pathology digitization has given rise to a strong increase in diagnostic assistance systems (“Computer-Aided Diagnosis”, or CAD) on whole slide scans (“Whole Slide images”, or WSI), also so-called virtual microscopy images. In particular, the detection of regions of interest in such images is a valuable aid for pathologists as well as for analysis algorithms which should focus on a particular region of interest (for example to make a cell count on a tumor area only, or to detect a tumor on a tissue area), which allows providing the final diagnosis more rapidly. For example, the detection of the tissue areas avoids analyzing the background and consequently accelerates the anomaly search or cell count algorithms, which are implemented only in the tissue area. In order to extract these regions of interest, it is necessary to have effective solutions for performing segmentation of an image of a sample of biological tissues and, for example, separating the foreground of the biological tissues and the background.

Conventionally, pathologists use one or more staining technique(s) on biological tissues. Staining is a well-known technique allowing demonstrating and identifying some cells or some cellular structures in biological tissues by staining these with more or less intense stainings and/or different colors. For example, the use of staining with hematoxylin-eosin (denoted HE, or H&E), commonly used for the detection of cancer cells, stains the nuclei in blue/violet, the cytoplasm in pink and the other basic cellular elements in pink/red. Immunohistochemistry (IHC) staining is commonly used to detect some cancers using specific markers, for example the Ki-67 antigen or the combination of the cytokeratin 8 and 18 (CK 8/18) antibodies, and generally stains the elements of the cell in blue/brown tones.

There are methods for segmenting images of biological tissues which are based on adaptive thresholdings, but these methods are very sensitive to variations in staining and are not very effective on a wide variety of images having different stainings. More recently, methods based on machine learning models have emerged. For example, some of these methods are based on the use of a machine learning model trained from annotated images, i.e. images of biological samples for which the regions of interest are known (for example, a segmentation binary mask verified by a pathologist and representing the contours of the tissues of the image of the sample).

However, in these methods, the training images are generally images of biological samples stained using one single stain, and the results are very degraded insofar as the model is applied to the detection of regions of interest in images of biological samples stained with a stain other than that one used for the training data. An alternative solution consists in training the learning model with annotated images stained with a wide range of stains. Nonetheless, such a solution is not optimum because it requires a large number of annotated images, which are both long and expensive to obtain.

Thus, there is a need for a method for detecting areas of interest in images of biological tissues which is effective irrespective of the staining that is used, and which does not require too much training data to train the detection model.

The present invention improves the situation.

### SUMMARY

The invention relates to a method for detecting regions of interest of a digital image of a biological sample stained with one or more staining(s), using a segmentation algorithm based on a machine learning model trained in a semi-supervised manner using training data, one portion of which is annotated, and the other not.

The annotated data typically comprise images of biological samples stained with a first staining, for example an HE staining, for which the tissue areas have been determined manually by an expert and are known.

The non-annotated data comprise pairs of paired images, each pair comprising a sample image stained with a second staining, and an image that is “similar” to an image of the same sample stained with the first staining. In other words, the paired images correspond to two images of the same sample, one stained with the second staining, and the other one stained with the first staining. For these images, the tissue areas are not known in advance.

The annotated data allow training the model so that it effectively determines the tissue areas in the images stained with the same staining (i.e. the first staining). The non-annotated data allow training the model on other stainings. The model thus obtained allows effectively detecting areas of interest in images of biological samples, irrespective of their stainings.

### BRIEF DESCRIPTION OF THE FIGURES

FIG. 1 is an example of a flowchart representing steps of a method for detecting regions of interest in an image of a biological sample according to one or more embodiment(s);

FIG. 2 shows an example of a flowchart representing a training of the learning model according to one or more embodiment(s);

FIG. 3 shows an example of determination of the portion of the cost function corresponding to the first set of training images according to one or more embodiment(s);

FIG. 4 shows an example of determination of the portion of the cost function corresponding to the second set of training images according to one or more embodiment(s);

FIG. 5 shows an example of a flowchart representing the generalization of the training of the learning model of FIG. 2 according to one or more embodiment(s);

FIG. 6 illustrates a device for implementing methods for training the machine learning model and/or for detecting regions of interest according to one or more embodiment(s).

### DETAILED DESCRIPTION

In the present invention, the terms hereinbelow are defined as follows:
By “region of interest” (or “area of interest”) of an image of a biological sample, it should be understood an area of the image to be detected with regards to the rest of the image. For example, the region of interest may be a tissue area, a tumor area, a stroma area, an epithelial area, a lesion, an artifact, etc.;
By “determining a region of interest in an image”, it should be understood determining a set of pixels of the image as belonging to a region of interest. This determination is done using a segmentation algorithm based on a machine learning model. A segmentation algorithm predicts, for an input piece of data, a class (or label, or tag). In the context of the present invention, the segmentation algorithm predicts, for each pixel of a received image, one class amongst two possible categories: “region of interest” and “outside a region of interest”. In the description, the terms “classify”, “segment” and “detect/determine a region of interest” are used interchangeably;
By “training data”, it should be understood data allowing training the learning model during the so-called learning or training phase;
By “staining technique”, it should be understood a technique for preparing biological samples to stain the tissues and increase the contrasts between the tissues and the background. Some areas, such as the tissue areas of the biological sample, are then tinted with some colors which depend on the technique being used. Such techniques are well-known to a person skilled in the art;
By “segmentation binary image” (or “segmentation binary mask”), it should be understood an image associated with a starting image, conventionally having the same size as the starting image and being obtained thanks to a segmentation method applied to the starting image. The segmentation binary image reveals the regions of interest of the starting image.

Typically, the pixels corresponding to the regions of interest may have a first color (for example white), and the pixels do not correspond to regions of interest of a second color (for example black). It should be noted that in the description hereinbelow, the term “segmentation binary image” does not necessarily refer to an image displayable on a display device, but any possible result of a segmentation by the algorithm, for example a table of values or classes for the pixels of the image.

A first aspect of the present disclosure relates to a computer-implemented method for training a machine learning model in a semi-supervised manner to determine a region of interest in an image of a biological sample, the method comprising:
receiving training data comprising:
   first images of biological samples prepared with a first staining technique, and information relating to regions of interest in said first images;
   N pairs of images, each pair of images comprising an image of a respective biological sample prepared with a nth staining technique, so-called n second image and an image similar to an image of the same biological sample prepared with the first staining technique, so-called n third image, N being an integer greater than or equal to 1 and n being an integer comprised between 2 and N+1; and
training the machine learning model with the training data;
   and wherein, said information relating to regions of interest in said first images also comprise segmentation binary images respectively associated with the first images of biological samples, each segmentation binary image comprising a first set of pixels corresponding to regions of interest of the corresponding first image of the biological sample, and a corresponding second set of pixels of the areas of the corresponding first image of the biological sample other than the regions of interest, the segmentation binary images respectively associated with the first images being so-called verified segmentation binary images, said method also comprising:
a) from each biological sample first image, generating a respective first segmentation binary image using current parameters of the machine learning model;
b) from each n biological sample second image, generating a respective n second segmentation binary image using current parameters of the machine learning model;
c) from each n third similar image, generating a respective n third segmentation binary image using current parameters of the machine learning model;
d) calculating a cost function on the basis of:
   a value representative of differences between the first segmentation binary images and the corresponding verified segmentation binary images; and
   N values representative of differences between the n second segmentation binary images and the corresponding n third segmentation binary images;

According to other advantageous aspects of the present disclosure, said method for semi-supervised training of a machine learning model comprises one or more of the following features, considered separately or in any technically-feasible combination:
the machine learning model is a deep learning model;
each n third image is generated from the respective n second image thanks to a colorimetric transformation;
the colorimetric transformation uses a residual circular generative adversarial network;
the value representative of the differences between the first segmentation binary images and the corresponding verified segmentation binary images depends on a mean squared error between the first segmentation binary images and the corresponding verified segmentation binary images; and the N values representative of the differences between the n second segmentation binary images and the corresponding n third segmentation binary images depend on a mean squared error between the n second segmentation binary images and the corresponding n third segmentation binary images;
the first staining technique is a hematoxylin-eosin staining and the N other staining techniques are based on one or more marker(s) of an immunohistochemistry, such as the Ki-67 antigen, the antibodies or a combination of the cytokeratin 8 and 18 (CK 8/18) antibodies;
N is equal to 1; and/or
the first staining technique is a hematoxylin-eosin staining and the second staining technique is based on an immunohistochemistry, or vice versa, the first staining technique is based on an immunohistochemistry and the second staining technique is a hematoxylin-eosin staining.

According to a particular aspect, the present disclosure relates to a computer-implemented method for semi-supervised training of a machine learning model to determine a region of interest in an image of a biological sample. The method may comprise:
receiving training data comprising:
   first images of biological samples prepared with a first staining technique, and information relating to regions of interest in said first images;
   pairs of images, each pair of images comprising an image of a respective biological sample prepared with a second staining technique and an image similar to an image of the same biological sample prepared with the first staining technique;
training the machine learning model with the training data.

In one or more embodiment(s), no information relating to regions of interest in the images of the pairs of images is received.

A biological sample image may typically be a digital image of a slide (also so-called a virtual slide or digitized slide). The region of interest to be detected may be any region of the image to be detected or isolated, for example for use in a diagnostic assistance context, such as a tissue area, an epithelial area, a stroma area, an artifact, a tumor area, a cell cluster having a particular structure, etc.

The information relating to the regions of interest in the first images may typically correspond to classification information of the pixels of the image, for example according to either one of the classes: “region of interest” and “outside a region of interest”. For example, the class of each pixel of each first image may be known (typically, it has been determined or validated by an expert) and represents the “ground truth”. Thus, the first images correspond to annotated training data. Conversely, for the pairs of images, it is not necessary to have information relating to the regions of interest in these images, such as the classes of the pixels of these images. The pairs of images correspond to non-annotated training data. Thus, the learning is done in a semi-supervised manner.

By “image similar to an image of the same biological sample prepared with the first staining technique”, it should be understood an image whose characteristics (contours, background, relative intensities of the pixels, etc.) are similar to those of an image of the same biological sample that has been or that would have been prepared with the first staining technique. As detailed hereinafter, such an image may be obtained either in a completely automatic manner, for example by generating it or by simulating it digitally from the image of the sample, or in a semi-manual manner, by applying techniques for restaining the slide containing the biological sample and by scanning the obtained new slide.

Thus, each pair of images comprises two images similar to images of the same biological sample prepared by two different staining techniques. In other words, the images of one pair “resemble” each other, but correspond to different stainings (for example, an image in the pink tones, and an image in the blue/brown tones). As detailed hereinbelow, there are several techniques for obtaining these pairs of images, in particular biological staining techniques (for example, by washing the biological tissue and then by restaining, or by performing successive longitudinal cuts of the sample and by staining each slice with a different color), or digital restaining techniques—also called colorimetric transformations (each pair comprises an image of a stained sample, and from this image, a “paired” image is simulated so as to represent the same sample, but stained with another staining). Advantageously, the phase of training the model is therefore done in a semi-supervised manner, and allows obtaining an effective model for detecting regions of interest (for example tissue areas) in virtual slides stained with the first or second staining technique, or by a mixture of the two techniques, or by a third staining technique which would give colors similar to those used in the training data. Indeed, even though annotations are available only for one single staining, the use of non-annotated data with another staining allows generalizing the detection to the second staining, for which no annotation is yet available. In other words, the invention allows using only annotations for one single type of staining (which considerably reduces the cost and time), and transposing the learning and the detection to other colorimetric domains.

In one or more embodiment(s), the machine learning model may be a deep learning model. For example, the machine learning model may be a convolutional neural network.

Indeed, such models are known to provide good results in image segmentation algorithms.

In one or more embodiment(s), each pair of images may comprise an image of a respective biological sample prepared with the second staining technique and an image simulating an image of the same biological sample prepared with the first staining technique.

In one or more embodiment(s), for each pair of images, the image of the biological sample prepared with the second staining technique may be called the second image and the image similar to an image of the same sample biologic prepared with the first staining technique may be called the third image. For each pair of images, each third image may be generated from the respective second image thanks to a colorimetric transformation.

By “second respective image”, it should be understood the second image from which the third image is generated. Of course, the terms “second image” and “third image” are introduced herein for simplicity and do not constitute a technical limitation. By “colorimetric transformation”, it should be understood a digital technique allowing staining again an image in one or more other color domain(s).

Advantageously, the use of a colorimetric transformation for staining again the images allows automatically obtaining pairs of images corresponding to the same biological sample, stained in two different color domains (corresponding to two different staining techniques).

In particular, the colorimetric transformation may use a generative adversarial network (GAN, standing for “generative adversarial network”), such as a circular generative adversarial network (or “Cycle GAN”), for example, a residual circular generative adversarial network (or “Residual Cycle GAN”).

Other colorimetric transformations may be used, for example transformations using color deconvolutions.

In one or more embodiment(s), the information relating to the regions of interest in the first images may comprise segmentation binary images respectively associated with the first images of biological samples, each segmentation binary image comprising a first set of pixels corresponding to regions of interest of the corresponding first image of the biological sample, and a second set of pixels corresponding to areas of the corresponding first image of the biological sample other than the regions of interest.

In particular, the segmentation binary images respectively associated with the first images may be called verified segmentation binary images. The method may comprise:
a) from each biological sample first image, generating a respective first segmentation binary image using current parameters of the machine learning model;
b) from each second biological sample image, generating a respective second segmentation binary image using current parameters of the machine learning model;
c) from each third image, generating a respective third segmentation binary image using current parameters of the machine learning model;
d) calculating a cost function on the basis of:
   a value representative of differences between the first segmentation binary images and the corresponding verified segmentation binary images; and
   a value representative of differences between the second segmentation binary images and the corresponding third segmentation binary images.

Each of the segmentation binary images may respectively comprise a first set of pixels corresponding to regions of interest of the corresponding image of the biological sample, and a second set of pixels corresponding to areas of the corresponding image of the biological sample other than the regions of interest. Steps a) to d) may be reiterated so as to minimize the cost function.

By current parameters of the learning model, it should be understood the values of the parameters during the current iteration. At the end of each iteration, the values of the parameters are updated to minimize the cost function, and during the next iteration, the model is applied to the images, with the updated values of the parameters.

Thus, advantageously, the cost function used for the learning model depends, on the one hand, on the difference (or “distance”) between the result of the segmentation on the annotated data and the annotations (the “truth”) and, on the other hand, the difference between the results of the segmentation on the pairs of non-annotated images.

In particular, the value representative of the differences between the first segmentation binary images and the corresponding verified segmentation binary images may depend on a mean squared error between the first segmentation binary images and the corresponding verified segmentation binary images; and the value representative of the differences between the second segmentation binary images and the corresponding third segmentation binary images depends on a mean squared error between the second segmentation binary images and the corresponding third segmentation binary images.

Of course, other measurements than the mean squared error are possible, for example the cross entropy, the Cohen kappa, the absolute value of the difference, the Jaccard index, the Dice coefficient, etc.

In one or more embodiment(s), one of the staining techniques may be a hematoxylin-eosin staining and the other staining technique may be based on immunohistochemistry. Of course, other staining techniques may be used, like Sirius red, PAS staining (standing for “Periodic Acid Schiff”), etc. Furthermore, the two staining techniques may correspond to two different immunohistochemistry techniques, for example with Ki-67 and with CK8-18.

Another aspect of the present disclosure relates to a computer-implemented method for determining a region of interest in an image of a biological sample prepared with a staining technique. The method may comprise:
receiving the image of the biological sample; and
determining a region of interest of the image thanks to a segmentation algorithm using a trained machine learning model according to one of the previously-described embodiments.

In this case, the image of a biological sample prepared with a staining technique is no longer a training piece of data, but an image in which it is desired to detect a region of interest. The “staining technique” used for the image to be segmented may be the first staining technique, the second staining technique, a mixture of the two techniques, or a staining technique staining the cells in colors similar to those of the first or second staining technique.

In one or more embodiment(s), the region of interest may be a tissue area, a tumor area, a stroma area, an epithelial area, an area corresponding to a lesion, or an area corresponding to an artifact.

Another aspect of the present disclosure relates to a computer device comprising a circuit configured to implement a method of training the machine learning model and/or a method for determining a region of interest in an image of a biological sample prepared with a staining technique.

Another aspect of the present disclosure relates to a computer program product including instructions for implementing steps of the method for training the machine learning model and/or a method for determining a region of interest in an image of a biological sample prepared with a staining technique, when this program is executed by a processor.

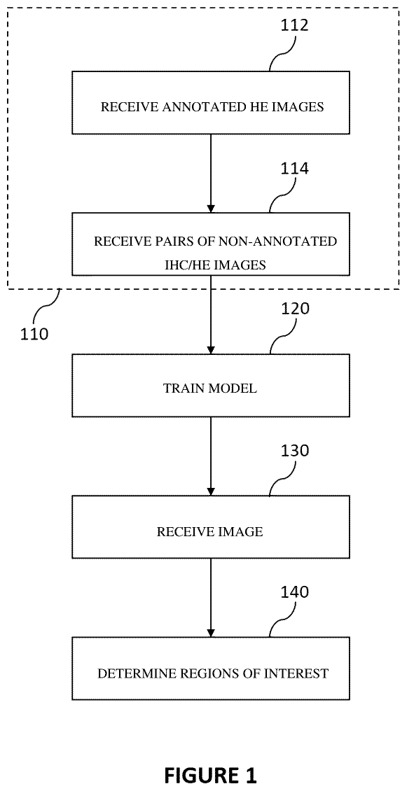

FIG. 1 is an example of a flowchart representing steps of a method for detecting regions of interest in an image of a biological sample according to one or more embodiment(s).

Training data (or “learning data”) of the machine learning model are received in a step 110. These training data comprise, on the one hand, annotated images of biological samples stained with a first staining technique (received in a step 112). For example, an “annotated” (or “labeled”, or “tagged”) image is an image in which each pixel of the image is associated with a label. For example, the label may be either “region of interest” or “outside a region of interest”. These labels may be determined or validated by experts, like pathologists or biologists, and represent the “truth”.

The training data also comprise non-annotated images of biological samples stained with a second staining technique, and simulated images of these same samples, if these had been stained with the first staining technique (received in a step 114). For these images, the labels of the pixels are not known.

Thus, the training data comprise, on the one hand, images of biological samples in which the regions of interest are stained according to some tints and images of biological samples in which the regions of interest are stained according to other tints (for example annotated images in the red-pink-violet tones, and non-annotated images in the blue-to-brown tones).

For simplicity, it is assumed hereinafter that the annotated images (received in step 112) are images of biological samples stained by HE and are hereinafter referred to as “HE images” or “annotated HE images”, and the non-annotated images (received in step 114) are images of biological samples stained by IHC and are hereinafter referred to as “IHC images” or “non-annotated IHC images”. The simulated images (also received in step 114) are referred to as “simulated HE images”. These images are obtained from the IHC images by a digital processing technique and simulate images of the same biological samples, if these had been stained by HE rather than by IHC. Of course, the staining techniques for the annotated data and the non-annotated data are interchangeable, and other staining techniques may be used. In particular, the two staining techniques may even correspond to two immunohistochemistry techniques with different markers. Furthermore, steps 112 and 114 may be implemented in this order or in another one, or in parallel.

There are several techniques for simulating HE images from corresponding IHC images. For example, it is possible to wash and stain again the slides by HE, and to recover digital images of these samples. Nonetheless, this method is technically difficult and very long to implement. It is also possible to make successive longitudinal cuts of a biological sample in order to obtain two slides, which could then be stained with two different staining techniques. In addition to requiring additional technical gestures, a drawback of this method is that, even though they are quite similar, the biological tissues are not exactly the same in the two slides, and it is often necessary to apply a registration between the obtained two images, which complicates the procedure. In one or more embodiment(s), it is possible to use color deconvolution techniques. In particularly advantageous embodiments, the simulated HE images are obtained thanks to machine learning models, such as generative adversarial networks (“generative adversarial networks”, or GANs), which have demonstrated good results in the generation of images. For example, it is possible to use a residual circular generative adversarial network (“residual Cycle-GAN”) as described in the article “Residual cyclegan for robust domain transformation of histopathological tissue slides” by Thomas de Bel et al., Medical Image Analysis, Volume 70, May 2020, 102004. Such a method allows obtaining domain transformation functions, to transform an image in the IHC-stained domain into an image in the HE-stained domain. The residual circular generative adversarial network has the same architecture as a conventional circular generative adversarial network (Cycle-GAN) comprising two sets of generators and discriminators, but in the residual circular generative adversarial network, the input image has a direct connection with the generated output image. In this manner, the generator does not need to reconstruct the image from a set of filter outputs, but only needs to add a residual, i.e. a change in color in the input image so that it resembles an image generated in the target domain. As it reduces the computing load on the generator, this approach requires less data and converges more rapidly than a conventional circular generative adversarial network.

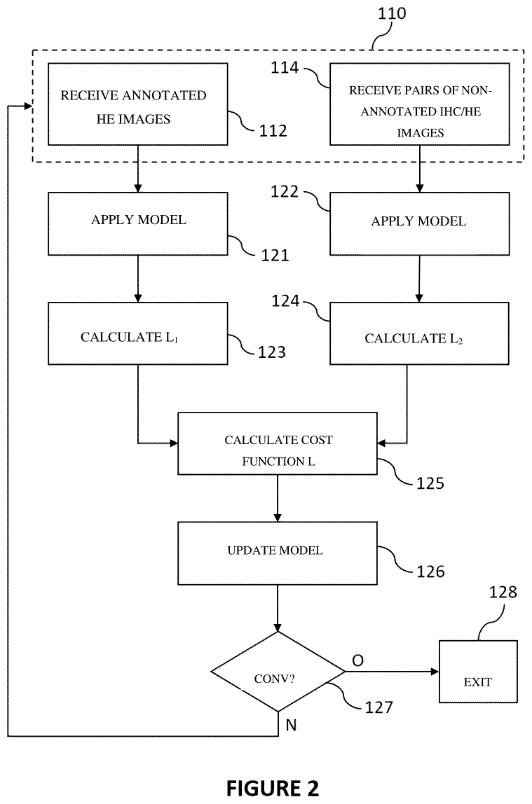

A machine learning model is trained (step 120) from the received training data. It should be recalled that the training of a learning model consists in determining a set of parameters of the model and/or in teaching the model a prediction function from the training data, so that the model could then predict the label of a received new piece of data (in the present application, predicting the labels of the pixels of a new received sample image). Only part of the training data being annotated (or labeled, or tagged), the training is therefore performed in a semi-supervised manner. Embodiments of the training of the learning model are detailed with reference to FIG. 2.

In one or more embodiment(s), the learning model may be a deep learning model, for example a convolutional neural network.

In step 130, an image of a biological sample is received for segmentation thereof (i.e. to determine the regions of interest therein). In step 140, a segmentation of the received image is performed thanks to the learning model trained in step 120. During this segmentation, the model predicts the labels of the pixels of the image received from the parameters and/or the prediction function determined during the training. Hence, upon completion of this segmentation, the pixels are labeled, either as “region of interest” or as “outside the region of interest” for example. Thus, the pixels corresponding to regions of interest are identified as such. The use of a machine learning model to perform image segmentation is known to a person skilled in the art and is not further detailed herein. For example, the U-Net architecture, also so-called “fully convolutional network” (or “fully convolutional network” in English) is well suited to the segmentation of biomedical images.

According to some embodiments, the method described with reference to FIG. 1 may also comprise the preparation of the samples and the recovery of the associated images. The preparation of the samples conventionally comprises a succession of steps known to a person skilled in the art, in particular: fixation (to immobilize and keep the sample over time in a state close to the living state, it is generally carried out by a fixing liquid or by freezing), inclusion (to stiffen the sample with an inclusion medium), cutting (in general by microtomy or cryotomy), staining or immunolabeling (to accentuate the contrasts between the constituent elements of the biological material and highlight specific cellular and tissue constituents), and finally mounting (to obtain slides ready to be observed). Afterwards, the slides may be observed under a microscope, and an overall view of the sample may be digitally reconstructed. The method illustrated in FIG. 1 may also comprise the annotation of the images of biological samples stained with the first staining technique (which are received afterwards in step 112).

FIG. 2 shows an example of a flowchart representing a training of the learning model according to one or more embodiment(s).

As mentioned hereinabove, during step 110, the training data of the machine learning model are received, and comprise for example annotated HE image data (received in step 112), as well as non-annotated IHC images with their corresponding simulated HE images (received in step 114).

In a known manner, during the training (or “learning”) phase of the learning model, the parameters of the model are estimated iteratively in order to minimize an objective function related to a cost function L, which represents the prediction error rate that the model applies on the training data.

In one or more embodiment(s), at each iteration, the current parameters of the model are applied to training images to determine regions of interest in these images. Thus, in step 121, the current model is used on all or part of the HE images to determine areas of interest in these HE images. During this step, the annotations are not used. In step 123, the regions of interest determined in step 121 are compared to the “truth”, i.e. to the regions of interest of the annotations, and a first portion of the cost function is determined from this comparison.

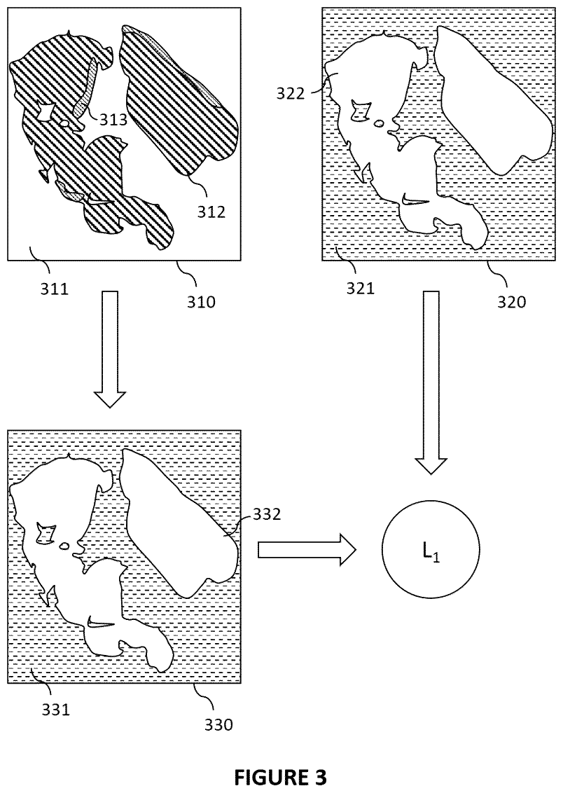

In particular, FIG. 3 shows an example of determination of this first portion of the cost function according to one or more embodiment(s). FIG. 3 shows an image 310, for example an HE image, and a corresponding image 320, which corresponds to the annotation of the image 310, i.e. to the regions of interest validated by an expert. The image 310 typically comprises different areas, for example: areas 311 corresponding to the background (in general barely or not tinted), and tissue areas 312, 313. In FIG. 3, the areas 311 corresponding to the background are represented in white. The tissue areas (i.e. in this example, the regions of interest) are represented by hatched portions 312, 313. The area 313 comprises hatches that are closer than the area 312, to represent more or less intense stainings of the regions of interest in the image 310. For example, on the image 310 of the biological sample stained by HE, the areas 312 represented with hatches that are more spaced may correspond to the pink areas of the sample, and the areas 313 with the hatches that are closer may correspond to violet or dark red areas.

The verified image 320 may be a binary image (also so-called “verified segmentation binary image”) revealing the validated regions of interest 322. Thus, on the image 320, the pixels corresponding to the background 321 may have a first value (for example, the value 0, corresponding to the black color) and the pixels of the regions of interest 322 may have a second value distinct from the first value (for example, the value 255 corresponding to the white color). By applying a segmentation algorithm using the current parameters of the model to the HE image 310, a segmentation binary image 330 may be determined. This segmentation binary image 330 may typically reveal the regions of interest 332 determined as such by the model. Thus, in the image 330, the pixels corresponding to the background 331 may have a first value (for example, the value 0, corresponding to the black color) and the pixels of the regions of interest 332 may have a second value distinct from the first value (for example, the value 255 corresponding to the white color).

In the example of FIG. 3, the training data 310, 320 and the output data 330 are images with the same size. Of course, It is not necessary to provide a representation of the classification of the pixels in the form of an image: instead of the binary images 320, 330, it is possible for example to store the values or the labels of the pixels in a matrix.

From the verified segmentation binary image 320 and the determined segmentation binary image 330, it is possible to determine the difference between the corresponding pixels of these two images and define a first portion L₁ of the cost function associated with the model from this difference.

For example, this first portion L₁ of the cost function may depend on the mean squared error between the verified segmentation binary image 320 and the determined segmentation binary image 330:

∥ [symbol] (I^{HE})−M^{HE}∥₂²

where I^{HE} is the HE image 310, [symbol] (I^{HE}) is the result of the segmentation algorithm applied to the I^{HE} image 310 (i.e. the determined segmentation binary image), M^{HE} is the verified segmentation binary image, and ∥·∥₂ represents the Euclidean norm (or 2-norm). It should be recalled that the mean squared error between two images A and B having respective sets of pixels a_{i,j} and b_{i,j} is proportional to:

$${‖ A - B ‖}_{2}^{2} = {\sum }_{i , j} {\vert {a}_{i , j} - {b}_{i , j} \vert}^{2}$$

It should be noted that the term ∥ [symbol] (I^{HE})−M^{HE}∥₂² conventionally corresponds to the cost function used to train the model in existing approaches based on machine learning from annotated data only. As detailed hereinbelow, in the present invention, a second term is added, to teach the model a variability in the stainings of the biological samples and enable the latter to segment images of biological samples stained with other segmentation techniques.

Referring again to FIG. 2, in step 122, the current model is used on all or part of the IHC images and on the corresponding simulated HE images, to determine areas of interest in these images. In step 124, the regions of interest determined during step 122 in the IHC images are compared with the regions of interest determined during step 122 in the corresponding simulated HE images, and a second portion of the cost function is determined from this comparison.

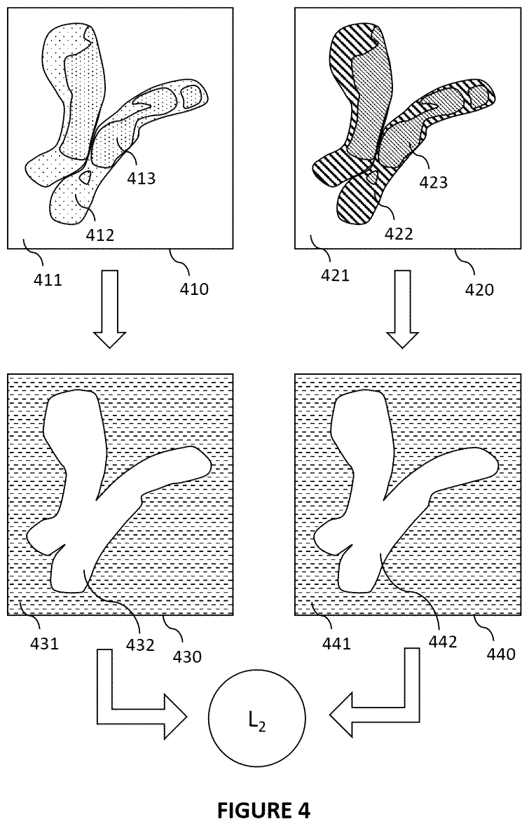

In particular, FIG. 4 shows an example of determination of this second portion of the cost function according to one or more embodiment(s). FIG. 4 shows an image 410, for example an IHC image, and a corresponding simulated HE image 420. The IHC image 410 comprises different areas, for example: areas 411 corresponding to the background (in general few or not tinted), and tissue areas 412, 413, which are the regions of interest in this example. In FIG. 4, the areas corresponding to the background are the white areas 411 of the image 410. The areas of interest are represented by dotted portions 412, 413. The density of the points in the area 413 is higher than in the area 412, to substantially represent intense stainings of the regions of interest in the image 410. For example, on the image 410 of the biological sample stained by IHC, the areas 412 represented with a lower density of points may correspond to the light brown areas of the sample, and the areas 413 with a higher density of points may correspond to dark brown areas.

Similarly, the corresponding simulated HE image 420 comprises different areas, for example: areas 421 corresponding to the background (shown in white in the figure) and areas of interest 422, 423, for example, biological tissues. These areas of interest are represented by hatched portions 422, 423. The area 423 comprises closer hatches than the area 422, to represent substantially intense stainings of the regions of interest in the image 420. For example, on the simulated HE image 420, the areas 422 represented with more spaced hatches may correspond to the clear pink areas of the sample, and the areas 423 with the closer hatches may correspond to violet and/or dark pink areas.

By applying a segmentation algorithm using the current parameters of the model to the IHC image 410, a segmentation binary image 430 may be determined. This segmentation binary image 430 could typically reveal the regions of interest 432 determined as such by the model. Thus, in the image 430, the pixels corresponding to the background 431 may have a first value (for example, the value 0, corresponding to the black color) and the pixels of the regions of interest 432 may have a second value distinct from the first value (for example, the value 255 corresponding to the white color).

Similarly, by applying the segmentation algorithm using the current parameters of the model to the simulated HE image 420, another segmentation binary image 440 may be determined. This segmentation binary image 440 may typically reveal the regions of interest 442 determined as such by the model. Thus, in the image 440, the pixels corresponding to the background 441 may have a first value (for example, the value 0, corresponding to the black color) and the pixels of the regions of interest 442 may have a second value distinct from the first value (for example, the value 255 corresponding to the white color).

In the example of FIG. 4, the training data 410, 420 and the output data 330, 440 are images with the same size. Of course, it is not necessary to provide a representation of the classification of the pixels in the form of images: instead of the binary images 430, 440, it is possible, for example, to store the values or labels of the pixels in a matrix.

From the obtained two segmentation binary images 430 and 440, it is possible to determine the difference between the corresponding pixels of these two images and to define a second portion L₂ of the cost function associated with the model from this difference.

For example, this first portion L₂ of the cost function may depend on the mean squared error between the segmentation binary image 430 obtained from an IHC image and the segmentation binary image 440 obtained from the corresponding simulated HE image:

∥ [symbol] (I^{IHC})− [symbol] ( [symbol] (I^{IHC}))∥₂²

where I^{IHC} is the RIC image 410 and [symbol] (I^{IHC}) its associated simulated image 420.

Referring again to FIG. 2, the cost function associated with the learning model could be determined afterwards (step 125) from the two portions determined in steps 123 and 124. For example, the cost function may be in the form:

$$L = {L}_{1} + {L}_{2} = {‖ ℱ ( {I}^{HE} ) - {M}^{HE} ‖}_{2}^{2} + λ {‖ ℱ ( {I}^{IHC} ) - ℱ ( 𝒢 ( {I}^{IHC} ) ) ‖}_{2}^{2}$$

where λ is a real regularization parameter comprised between 0 and 1. Advantageously, the value of λ may be variable during the learning phase, for example to progressively increase between 0 and 1. Thus, the weight of the second portion of the cost function in the “total” cost function increases during the learning. This enables the model to first learn to predict the regions of interest in a domain in which the truth is known (i.e. on the annotated HE images) before being extended to another domain in which the truth is unknown (i.e. the non-annotated IHC images).

Of course, other cost functions are possible (in particular a weighted sum of the mean squared errors with other weightings than 1 and λ), insofar as they depend on the differences between the segmentation results in the two groups of training data. Furthermore, other difference measurements between images may be used instead of the mean squared error, like the Cohen kappa coefficient (K) (κ), the cross entropy, the absolute value of the difference, the Jaccard index, the Dice coefficient, etc.

Thus, the cost function advantageously takes into account, on the one hand, the segmentation error on annotated data in one single domain and, on the other hand, the segmentation error on non-annotated data originating from different domains. This allows for a more robust segmentation on images that do not necessarily originate from the same domain (i.e. which are not derived from samples prepared with the same staining technique), without requiring a large amount of annotated data (in particular in several domains, which is expensive and long to obtain). Schematically, the training of the machine learning model using the annotated HE images allows efficiently segmenting new HE images, and the training of the learning model on corresponding pairs of IHC/HE images allows extending the segmentation to other staining types (in particular to segment new IHC images, even though the training data do not comprise any annotated IHC image). Thus, the obtained model allows efficiently segmenting images of biological samples, irrespective of the staining techniques used to obtain them. In particular, the model is effective for determining the regions of interest on images stained by IHC, but also by staining techniques other than HE or IHC. Furthermore, it is known that, for the same staining technique, the brightness and the contrast of the digital image depends on the used scanner type. Thus, for two different scanners, the images of the same stained slide with the same staining technique may have slightly different colors. The model thus trained is also effective in determining the regions of interest in images originating from different scanners and featuring differences in staining.

Afterwards, the parameters of the model may be updated so as to minimize this cost function (step 126). If a convergence criterion is reached (test 127, arrow “O”), the learning phase stops (step 128). Otherwise (test 127, arrow “N”), all or some of steps 112, 114, 121 to 127 are reiterated with the parameters updated in step 126. For example, the convergence criterion may be based on the difference in the values of the parameters between the estimates of the parameters of the model between two (or more) successive iterations: as long as this difference is greater than a predefined threshold, the convergence criterion is not reached.

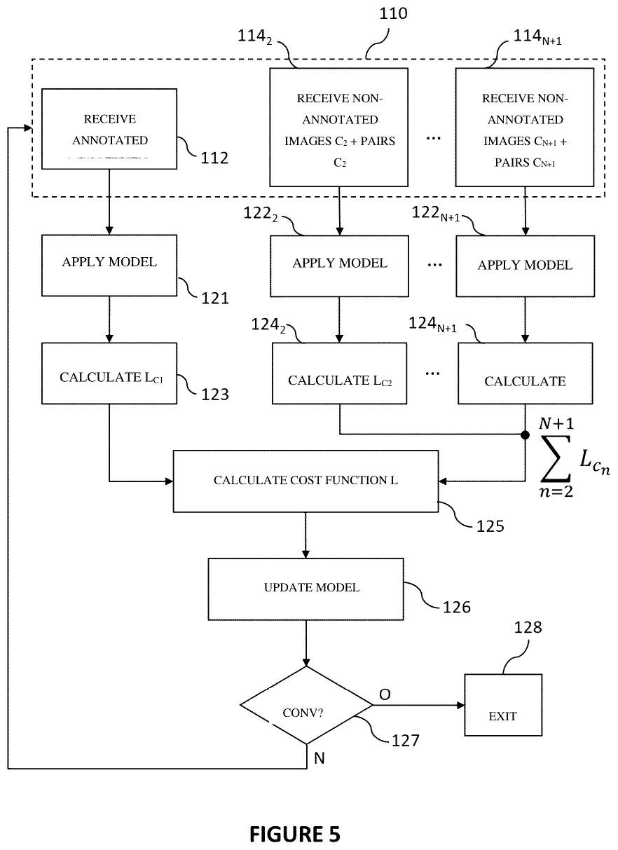

Advantageously, the method for detecting regions of interest in an image of a biological sample and the training of the learning model described before could be generalized as illustrated in FIG. 5.

In these embodiments, the training data comprise, on the one hand, annotated images of biological samples stained with a first staining technique C₁ (received in step 112 as described before). This first staining technique C₁ may be considered as the reference staining technique. Advantageously, this first staining technique may be a staining with hematoxylin-eosin (i.e. C₁=HE) like in the previous embodiments.

The training data also comprise N pairs of non-annotated images of biological samples stained with N different stainings C₂ to C_{N+1} (received in steps 114₂ to 114_{N+1} similar to step 114 described before), where N is an integer greater than or equal to 1. Each pair of non-annotated images comprises an image of a respective biological sample prepared with an nth staining technique, so-called n second image and an image similar to an image of the same biological sample prepared with the first staining technique, so-called n third image, where n is an integer comprised between 2 and N+1.

Advantageously, these N other staining techniques C₂ to C_{N+1} are based on one or more marker(s) of an immunohistochemistry (i.e. Cₙ=HC), such as the Ki-67 antigen, the antibodies or a combination of the cytokeratin 8 and 18 (CK 8/18) antibodies.

In the same manner as before, the received images may be segmented in order to determine regions of interest therein, using the current parameters of the machine learning model.

Thus, the information relating to regions of interest in the first images also comprise segmentation binary images respectively associated with the first images of biological samples. The segmentation binary images respectively associated with the first images are so-called verified segmentation binary images. Respectively, each n second image corresponds to an n second segmentation binary image, and each n third image corresponds to an n third segmentation binary image.

In addition, each of these segmentation binary images comprises a first set of pixels corresponding to regions of interest of the corresponding image of the biological sample, and a second set of pixels corresponding to the areas of the corresponding image of the biological sample other than the regions of interest.

As regards the different cost functions, these may be written as follows:

$$\begin{matrix}{L}_{1} = {‖ ℱ ( {I}^{C 1} ) - {M}^{C 1} ‖}_{2}^{2} \\ {L}_{n} = ‖ F ( {I}^{Cn} ) - ℱ ( G ( {I}^{Cn} ) ) {‖}_{2}^{2}\end{matrix}$$

Where:
L₁ corresponds to the cost function calculated between the verified first segmentation binary image and the first binary image obtained from the first image prepared with the first staining C₁, and in the case where L1 is considered as the mean squared error between the two images;
I^{C1} is the first image prepared with the first staining C₁, [symbol] (I^{C1}) is the result of the segmentation algorithm applied to the image I^{C1} (i.e. the determined segmentation binary image), M^{C1} is the verified segmented binary image, and ∥·∥₂ represents the Euclidean norm (or 2-norm); and
Ln corresponds to the cost function calculated between the n second segmentation image I^{Cn} and the n third segmentation image G(I^{Cn}), in the particular case where Ln is considered as the mean squared error between these two images.

It is then possible to define the overall cost function associated with the learning model from steps 123 and 124₂ to 124ₙ, as follows:

$$L = {L}_{1} + {\sum }_{n = 2}^{N + 1} {L}_{n} = {‖ ℱ ( {I}^{C 1} ) - {M}^{C 1} ‖}_{2}^{2} + {\sum }_{n = 2}^{N + 1} {λ}_{n} {‖ ℱ ( {I}^{Cn} ) - ℱ ( 𝒢 ( {I}^{Cn} ) ) ‖}_{2}^{2}$$

Where λₙ is a real regularization parameter comprised between 0 and 1. Advantageously, the value of λₙ may be variable during the learning phase, for example to progressively increase between 0 and 1. Thus, the weight of the second portion of the cost function in the “total” cost function increases during the learning. This enables the model to first learn to predict the regions of interest in a domain in which the truth is known (i.e. on the annotated images C₁) before being extended to another domain in which the truth is unknown (i.e. the non-annotated images Cₙ).

Other cost functions are also possible as described before.

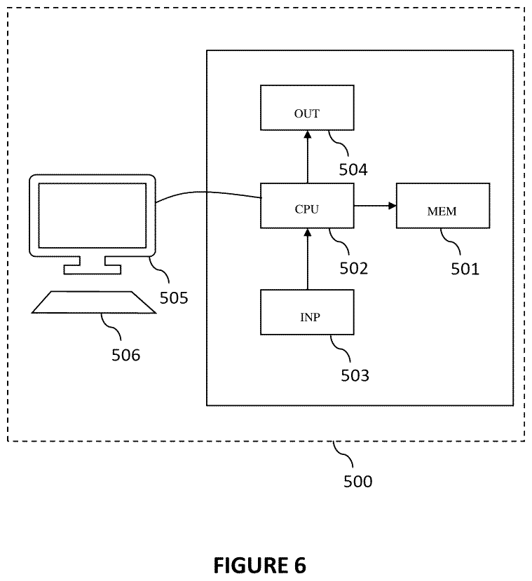

FIG. 6 illustrates a device for implementing methods for training the machine learning model and/or for detecting regions of interest according to one or more embodiment(s).

The device 500 may comprise a memory 501 for storing instructions allowing implementing steps of the methods for training the machine learning model and for detecting regions of interest in a biological sample image using this model, the received data, in particular the training data and/or the images of biological samples to be segmented, and temporary data for carrying out all or some of the steps of the previously-described methods.

The device 500 further comprises a control circuit 502, an input interface 503 for receiving data, in particular the training data and/or the images of biological samples to be segmented, and an output interface 504 for providing output data, like parameters of the learning model or regions of interest of a biological sample image.

In one or more embodiments, in order to enable an easy interaction with a user, the device 500 may be in the form of a computer including a screen 505 and a keyboard 506. The device 500 may be a mobile terminal, a computer, a computer network, an electronic component, or another apparatus comprising a processor operatively coupled to a memory, as well as, according to the selected embodiment, a data storage unit, and other associated hardware elements like a network interface and a media reader for reading a removable storage medium and writing on such a medium. For example, the removable storage medium may be a compact disk (CD), a digital video/versatile disk (DVD), a flash disk, a USB key, etc. Depending on the embodiment, the memory, the data storage unit or the removable storage medium contains instructions which, when they are executed by the control circuit 502, cause the control circuit 502 to control the input interface 503, the output interface 504, and the memory 501.

The control circuit 504 may be a component implementing a processor or a computing unit to train a learning model and/or detect regions of interest in a biological sample image according to the proposed method and to control the units 501, 503 and 504 of the device 500. Furthermore, the device 500 may be implemented in a software form (“software” or “firmware”), in which case it is in the form of a program executable by a processor, corresponding for example to a downloadable application executable on a piece of equipment of the smartphone or tablet type, as described hereinabove, or in a hardware form (or “hardware”), like an application-specific integrated circuit (ASIC), a system-on-chip (or SOC), or in the form of a combination of hardware and software elements, for example a software program intended to be loaded and executed on an FPGA type (standing for “Field Programmable Gate Array”) component. The SOCs are embedded systems which integrate all the components of an electronic system into one single chip. An ASIC (standing for “Application Specific Integrated Circuit”) is a specialized electronic circuit which groups together customized functions for a given application. ASICs are generally configured during manufacture thereof and can only be simulated by the user. FPGA-type programmable logic circuits have electronic circuits that are reconfigurable by the user. The device 500 may also use hybrid architectures, for example architectures based on a CPU+FPGA, a GPU (standing for “Graphics Processing Unit”) or an MPPA (standing for “Multi-Purpose Processor Array”).

Moreover, the flowchart shown in FIG. 1 is a typical example of a program, some instructions of which could be carried out by the described device. In this respect, FIG. 1 may correspond to the flowchart of the general algorithm of a computer program in a particular embodiment. Of course, the present invention is not limited to the embodiments described hereinbefore as examples, it covers other variants. For example, although the method is described on two staining techniques, it is possible to train the model on non-annotated data originating from several different fields (i.e. non-annotated images of biological samples prepared with several different staining techniques). Thus, the trained model could be used to segment a wide variety of images of biological samples, stained with different staining techniques. Furthermore, even though the invention is described herein in the context of a binary segmentation (area of interest or outside area of interest), it can be generalized to a number of classes strictly greater than two, and to other types of classes (for example, non-tissue area, tumor tissue area and non-tumor tissue area).

1-11. (canceled)

12. A computer-implemented method for training a machine learning model in a semi-supervised manner to determine a region of interest in an image of a biological sample, the method comprising:
receiving training data comprising:
first images of biological samples prepared with a first staining technique, and information relating to regions of interest in said first images; and
N pairs of images, each pair of images comprising an image of a respective biological sample prepared with a nth staining technique, so-called n second image and an image similar to an image of the same biological sample prepared with the first staining technique, so-called n third image, N being an integer greater than or equal to 1 and n being an integer comprised between 2 and N+1; and
training the machine learning model with the training data; and
wherein, said information relating to regions of interest in said first images also comprise segmentation binary images respectively associated with the first images of biological samples, each segmentation binary image comprising a first set of pixels corresponding to regions of interest of the corresponding first image of the biological sample, and a corresponding second set of pixels of the areas of the corresponding first image of the biological sample other than the regions of interest, the segmentation binary images respectively associated with the first images being so-called verified segmentation binary images, the method further comprising:
a) from each biological sample first image, generating a respective first segmentation binary image using current parameters of the machine learning model;
b) from each n biological sample second image, generating a respective n second segmentation binary image using current parameters of the machine learning model;
c) from each n third similar image, generating a respective n third segmentation binary image using current parameters of the machine learning model;
d) calculating a cost function on the basis of:
a value representative of differences between the first segmentation binary images and the corresponding verified segmentation binary images; and
N values representative of differences between the n second segmentation binary images and the corresponding n third segmentation binary images;
wherein each of the segmentation binary images respectively comprises a first set of pixels corresponding to regions of interest of the corresponding image of the biological sample, and a second set of pixels corresponding to areas of the corresponding image of the biological sample other than the regions of interest; and
wherein steps a) to d) are reiterated so as to minimize the cost function.

13. The method according to claim 12, wherein the machine learning model is a deep learning model.

14. The method according to claim 12, wherein for each n third image is generated from the respective n second image thanks to a colorimetric transformation.

15. The method according to claim 14, wherein the colorimetric transformation uses a residual circular generative adversarial network.

16. The method according to claim 12, wherein the value representative of the differences between the first segmentation binary images and the corresponding verified segmentation binary images depends on a mean squared error between the first segmentation binary images and the corresponding verified segmentation binary images; and the N representative values of the differences between the n second segmentation binary images and the corresponding n third segmentation binary images depend on a mean squared error between the n second segmentation binary images and the corresponding n third segmentation binary images.

17. The method according to claim 12, wherein the first staining technique is a hematoxylin-eosin staining and the N other staining techniques are based on one or more immunohistochemistry marker(s), such as the Ki-67 antigen, the antibodies or a combination of the cytokeratin 8 and 18 (CK 8/18) antibodies.

18. The method according to claim 12, wherein N is equal to 1.

19. The method according to claim 18, wherein the first staining technique is a hematoxylin-eosin staining and the second staining technique is based on an immunohistochemistry, or vice versa the first staining technique is based on an immunohistochemistry and the second staining technique is a hematoxylin-eosin staining.

20. A computer-implemented method for determining a region of interest in an image of a biological sample prepared with a staining technique, the method comprising:
receiving the image of the biological sample; and
determining a region of interest of the image thanks to a segmentation algorithm using a trained machine learning model according to claim 12.

21. A computer device comprising a circuit configured to implement a method according to claim 12.

22. A computer program product including instructions for implementing steps of the method according to claim 12, when this program is executed by a processor.
